(19) United States
(12) Patent Application Publication
(10) Pub. No.: US 2025/0378093 A1
(43) Pub. Date: Dec. 11, 2025

(54) INFORMATION PROCESSING APPARATUS, SET GENERATION METHOD, AND NON-TRANSITORY COMPUTER-READABLE MEDIUM

(71) Applicant: NEC Corporation, Tokyo (JP)

(72) Inventor: Yousuke MOTOHASHI, Tokyo (JP)

(73) Assignee: NEC Corporation, Tokyo (JP)

(21) Appl. No.: 19/225,109

(22) Filed: Jun. 2, 2025

(30) Foreign Application Priority Data
Jun. 7, 2024 (JP) 2024-093258

(51) Int. Cl. G06F 16/3329; G06F 16/334

(52) U.S. Cl. CPC G06F 16/3329; G06F 16/334

(57) ABSTRACT

A set of questions covering the entire target document is generated. An information processing apparatus includes: a determination unit that determines similarity of content for multiple question sentences regarding the content of a target document, which are generated by a generative model trained to generate question sentences regarding the content of a document; and a set generation unit that generates a set of question sentences including the multiple question sentences generated by the generative model based on a determination result of the determination unit. Thus, for example, it is also possible to generate a set of question sentences optimized for a Q&A collection or for training data of the generative model.

### INCORPORATION BY REFERENCE

This application is based upon and claims the benefit of priority from Japanese patent application No. 2024-093258, filed on Jun. 7, 2024, the disclosure of which is incorporated herein in its entirety by reference.

### TECHNICAL FIELD

The present disclosure relates to an information processing apparatus, a set generation method, and a non-transitory computer-readable medium.

### BACKGROUND ART

A technology for generating various sentences using a model trained through machine learning is known. An example of a technology for generating a sentence using a model trained through machine learning includes a text generation apparatus described in Japanese Patent No. 7133689. The text generation apparatus outputs reviews and ratings for an item by using a deep-learning model trained on user reviews and ratings for various items.

“Sahil Kale and others, ‘FAQ-Gen: An automated system to generate domain-specific FAQs to aid content comprehension’, URL: https://arxiv.org/abs/2402.05812, 2024” discloses a system that generates a Frequently Asked Question (FAQ). The system uses a text-to-text transformation model to generate an FAQ that increases accuracy and relevance based on text content in a specific domain.

The technology for automatically generating text as described above can be utilized in various applications. For example, documents such as user manuals for products and services may include a Question and Answer (Q&A) or a Frequently Asked Question (FAQ) related to the content of the documents. It is advantageous to enable automatic generation of such a Q&A or the like by utilizing the technology for automatically generating text. A combination of a question and an answer regarding the content of the document can also be used as training data for training a generative model that generates an answer based on the content of the document in response to the question regarding the content of the document.

Here, in a case where the technology for automatically generating text is applied to the above-described application, it is desirable to generate a set of questions covering the entire document. However, there is no technology for evaluating the coverage of questions, and therefore it has been difficult to generate a set of questions covering the entire document. This is not limited to the above-described user manual, and is a problem that occurs in common in a case where a generative model is caused to generate a question about the content of an arbitrary document.

For example, in the system described in “Sahil Kale and others, ‘FAQ-Gen: An automated system to generate domain-specific FAQs to aid content comprehension’, URL: https://arxiv.org/abs/2402.05812, 2024”, the text extracted from the input document is divided into multiple chunks, a domain is specified for each chunk, a question is generated for each domain based on the specified domain and text content, and an answer to the generated question is generated. Here, among the multiple chunks, there may be chunks that include many items to be asked, or conversely, there may be chunks that lack items to be asked. Therefore, in the system that does not have a mechanism for adjusting the number of questions generated for each chunk, and which is described in “Sahil Kale and others, ‘FAQ-Gen: An automated system to generate domain-specific FAQs to aid content comprehension’, URL: https://arxiv.org/abs/2402.05812, 2024”, it is difficult to generate a set of questions substantially covering the entire input document.

### SUMMARY

The present disclosure has been made in view of such a problem, and an example object thereof is to provide a technology capable of generating a set of questions covering the entire target document. An example object of the present disclosure is to provide an information processing apparatus, a set generation method, and a non-transitory computer-readable medium.

According to a first example aspect of the present disclosure, there is provided an information processing apparatus including: a determination unit for determining similarity of content for multiple question sentences regarding the content of a target document, which are generated by a generative model trained to generate question sentences regarding the content of a document; and a set generation unit for generating a set of question sentences including the multiple question sentences generated by the generative model based on a determination result of the determination unit.

According to a second example aspect of the present disclosure, there is provided a set generation method including causing at least one processor to execute: a determination step of determining similarity of content for multiple question sentences regarding the content of a target document, which are generated by a generative model trained to generate question sentences regarding the content of the document; and a set generation step of generating a set of question sentences including the multiple question sentences generated by the generative model based on a determination result in the determination step.

According to a third example aspect of the present disclosure, there is provided a non-transitory computer-readable medium storing a set generation program for causing a computer to execute: determination processing of determining similarity of content for multiple question sentences regarding the content of a target document, which are generated by a generative model trained to generate question sentences regarding the content of a document; and set generation processing of generating a set of question sentences including the multiple question sentences generated by the generative model based on a determination result of the determination processing.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of a set generation method according to the present disclosure;

FIG. 3 is a block diagram illustrating a configuration of another information processing apparatus according to the present disclosure;

FIG. 4 is a flowchart illustrating an example of processing executed by the information processing apparatus illustrated in FIG. 3;

FIG. 5 is a flowchart illustrating another example of processing executed by the information processing apparatus illustrated in FIG. 3;

FIG. 6 is a flowchart illustrating still another example of processing executed by the information processing apparatus illustrated in FIG. 3; and

FIG. 7 is a block diagram illustrating a configuration of a computer that functions as an information processing apparatus according to the present disclosure.

### EXAMPLE EMBODIMENTS

Hereinafter, example embodiments of the present disclosure will be described. However, the present disclosure is not limited to the following illustrative embodiments, and various modifications can be made within the scope described in the claims. For example, the example embodiments obtained by appropriately combining the technologies (some or all of the products or methods) adopted in the following illustrative embodiments can also be included in the scope of the present disclosure. Example embodiments obtained by appropriately omitting some of the technologies adopted in the following illustrative embodiments can also be included in the scope of the present disclosure. Effects to be described in the following illustrative embodiments are examples of effects expected in the illustrative embodiments, and do not define the scope of the present disclosure. That is, example embodiments that do not achieve the effects to be described in the following illustrative embodiments can also be included in the scope of the present disclosure.

### First Illustrative Embodiment

A first illustrative embodiment that is an example embodiment of the present disclosure will be described in detail with reference to the drawings. The present illustrative embodiment is a basic mode of each illustrative embodiment to be described below. The application range of each technology adopted in the present illustrative embodiment is not limited to the present illustrative embodiment. That is, each technology adopted in the present illustrative embodiment can also be adopted in other illustrative embodiments included in the present disclosure as long as no particular technical problem occurs. Each technology illustrated in the drawings referred to for describing the present illustrative embodiment can also be adopted in other illustrative embodiments included in the present disclosure as long as no particular technical problem occurs.

### (Configuration of Information Processing Apparatus 1)

A configuration of an information processing apparatus 1 according to the present illustrative embodiment will be described with reference to FIG. 1. FIG. 1 is a block diagram illustrating the configuration of the information processing apparatus 1. As illustrated in FIG. 1, the information processing apparatus 1 includes a determination unit 101 and a set generation unit 102.

The determination unit 101 determines the similarity of the content for multiple question sentences regarding the content of a target document, which are generated by a generative model trained to generate question sentences regarding the content of the document. Hereinafter, the “document to be targeted” is referred to as a “target document”.

The target document is a document for which a set of question sentences regarding the content of the target document is generated, and is only required to be any document as long as the target document includes at least one sentence. For example, one or multiple pieces of text may be set as the target document, or a part of the text (for example, chapter, clause, and paragraph) may be set as the target document. For example, a user manual for a product or service may be used as the target document. Thus, a set of question sentences regarding the content of the product or service can be generated. For example, a document describing what to do when an injury or illness occurs may be set as the target document. Thus, a set of question sentences regarding what to do when an injury or illness occurs can be generated. As described above, the information processing apparatus 1 can also be used for healthcare.

The generative model is only required to be a model trained to generate a question sentence regarding the content of the document. For example, as the above-described generative model, a language model trained on the arrangement of the components (such as words) of a sentence described in natural language and the arrangement of the sentences in text may be applied. A general-purpose language model finely tuned in such a way as to be suitable for generation of a question sentence may be used as the generative model.

The determination result of the similarity may indicate whether or not there is similarity, or may indicate the degree of similarity. A method for determining the similarity is not particularly limited. For example, the determination unit 101 may determine the similarity of the content of the question sentence using the language model as described above. For example, the determination unit 101 may transforms the question sentence into a vector and compute the similarity between the vectors. The determination of the similarity using the language model will be described in a second illustrative embodiment.

The set generation unit 102 generates a set of question sentences including multiple question sentences generated by the generative model based on the determination result of the determination unit 101. Various methods can be applied as a method for generating a set based on the determination result of the determination unit 101, that is, the similarity of the content of the question sentences. A specific example of the method for generating a set is described in the second illustrative embodiment.

As described above, the information processing apparatus 1 according to the present illustrative embodiment adopts a configuration including the determination unit 101 that determines the similarity of content for multiple question sentences regarding the content of a target document, which are generated by the generative model trained to generate question sentences regarding the content of the document, and the set generation unit 102 that generates a set of question sentences including the multiple question sentences generated by the generative model based on the determination result of the determination unit 101.

Here, it is assumed that when the generative model is caused to generate multiple question sentences regarding the content of the target document, all the generated question sentences are not similar to other question sentences. In this case, it is considered that there is a high possibility that these question sentences cannot cover the entire target document. This is because there is a high possibility that a question sentence having similar content is generated when the generative model is caused to repeat the generation of the question sentence until a set of question sentences covering the entire document is generated.

It is assumed that, when the generative model is caused to generate multiple question sentences regarding the content of the target document, among the generated question sentences, a large number of question sentences having content similar to that of other question sentences are included. In this case, question sentences related to a part of the target document may be intensively generated. Thus, it is considered that there is a high possibility that these question sentences cannot cover the entire target document.

The above description indicates that the similarity of the content in the multiple question sentences generated by the generative model can be a metric for evaluating whether or not the multiple question sentences covers the entire target document.

Therefore, the information processing apparatus 1 adopts a configuration in which the similarity of the content of multiple question sentences generated by the generative model is determined, and a set of question sentences including the multiple question sentences generated by the generative model is generated based on the determination result. Since the similarity described above serves as a metric for determining whether or not multiple question sentences covers the entire target document, the information processing apparatus 1 can achieve the effect of generating a set of questions covering the entire target document. In the information processing apparatus 1, for example, it is also possible to generate a set of question sentences optimized for a Q&A collection or for training data of the generative model.

### (Set Generation Program)

The functions of the above-described information processing apparatus 1 can also be implemented by a program. A set generation program according to the present illustrative embodiment causes a computer to function as a determination means for determining the similarity of content for multiple question sentences regarding the content of a target document, which are generated by the generative model trained to generate question sentences regarding the content of the document, and a set generation means for generating a set of question sentences including the multiple question sentences generated by the generative model based on the determination result of the determination means. According to this set generation program, it is possible to generate a set of questions covering the entire target document.

### (Flow of Set Generation Method)

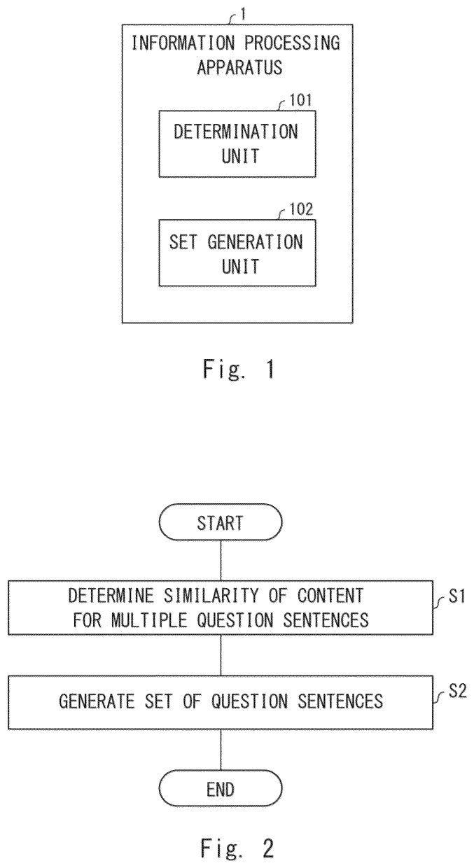

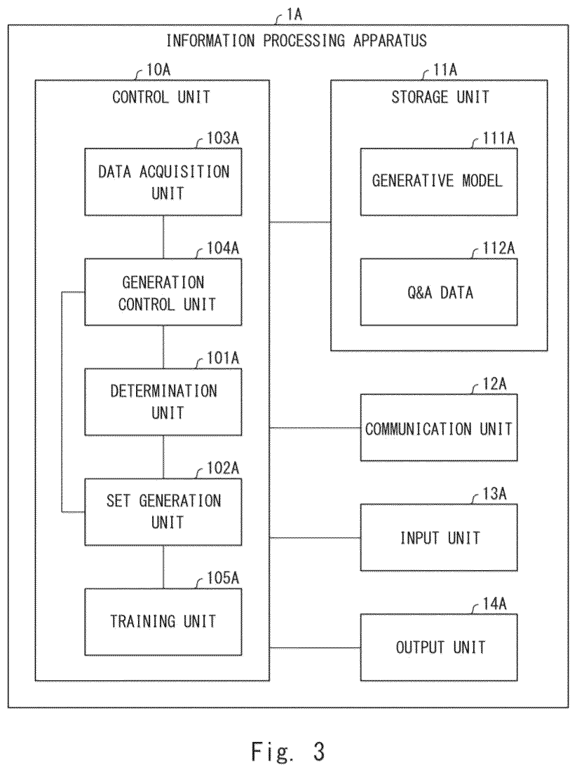

A flow of a set generation method according to the present illustrative embodiment will be described with reference to FIG. 2. FIG. 2 is a flowchart illustrating the flow of the set generation method according to the present disclosure. An entity that executes steps in this set generation method may be a processor included in the information processing apparatus 1, may be a processor included in another apparatus, or may be a processor included in an apparatus having different entities that each execute each step.

In S1 (determination step), at least one processor determines the similarity of the content for multiple question sentences regarding the content of a target document, which are generated by a generative model trained to generate question sentences regarding the content of the document.

In S2 (set generation step), at least one processor generates a set of question sentences including the multiple question sentences generated by the generative model based on the determination result of S1.

As described above, in the set generation method according to the present illustrative embodiment, at least one processor adopts a configuration including the determination step of determining the similarity of content for the multiple question sentences regarding the content of a target document, which are generated by the generative model trained to generate question sentences regarding the content of the document, and the set generation step of generating a set of question sentences including the multiple question sentences generated by the generative model based on the determination result in the determination step. Therefore, in the set generation method according to the present illustrative embodiment, it is possible to generate a set of questions covering the entire target document.

### Second Illustrative Embodiment

A second illustrative embodiment that is an example embodiment of the present disclosure will be described in detail with reference to the drawings. The application range of each technology adopted in the present illustrative embodiment is not limited to the present illustrative embodiment. That is, each technology adopted in the present illustrative embodiment can also be adopted in other illustrative embodiments included in the present disclosure as long as no particular technical problem occurs. Each technology illustrated in each drawing referred to for describing the present illustrative embodiment can also be adopted in other illustrative embodiments included in the present disclosure as long as no particular technical problem occurs.

### (Configuration of Information Processing Apparatus 1A)

A configuration of an information processing apparatus 1A according to the present illustrative embodiment will be described with reference to FIG. 3. FIG. 3 is a block diagram illustrating the configuration of the information processing apparatus 1A. The information processing apparatus 1A is an apparatus having a function for generating a set of questions covering the entire target document. The information processing apparatus 1A may be an apparatus having a function for mainly generating a set of questions, or may be a general-purpose apparatus having other functions. The information processing apparatus 1A may be a stationary apparatus or a portable apparatus.

As illustrated in FIG. 3, the information processing apparatus 1A includes a control unit 10A that integrally controls each unit of the information processing apparatus 1A, and a storage unit 11A that stores various types of data used by the information processing apparatus 1A. The information processing apparatus 1A includes a communication unit 12A for the information processing apparatus 1A to communicate with another apparatus, an input unit 13A that receives input to the information processing apparatus 1A, and an output unit 14A for the information processing apparatus 1A to output data. The control unit 10A includes a data acquisition unit 103A, a generation control unit 104A, a determination unit 101A, a set generation unit 102A, and a training unit 105A. The storage unit 11A stores a generative model 111A and Q&A data 112A.

The data acquisition unit 103A acquires a document (referred to as a target document as in the first illustrative embodiment) for which a set of questions is generated. As in the first illustrative embodiment, the target document is a document for which a set of question sentences regarding the content of the target document is generated, and is only required to be any document as long as the target document includes at least one sentence.

The generation control unit 104A causes the generative model 111A to generate a question sentence regarding the content of the target document. More specifically, the generation control unit 104A causes the generative model 111A to generate a question sentence by inputting a prompt including a target document and a sentence instructing to generate a question sentence regarding the content of the target document to the generative model 111A. As the generative model 111A, a generative model stored in a device outside the information processing apparatus 1A may be used. In this case, the generation control unit 104A transmits a prompt and a target document to an external device to generate a question sentence, and acquires the generated question sentence from the apparatus.

The generation control unit 104A causes the generative model 111A to generate an answer sentence to the generated question sentence, similarly to the case of generating the question sentence. The generation control unit 104A may cause the generative model 111A to generate a set of a question sentence and its corresponding answer sentence. The generation control unit 104A may use different generative models in the case of generating the question sentence and in the case of generating the answer sentence.

As described above, the information processing apparatus 1A may include the generation control unit 104A that causes the generative model 111A trained to generate an answer sentence to the question sentence regarding the content of the document to generate an answer sentence to each question sentence included in the set generated by the set generation unit 102A. Thus, in addition to the effect obtained by the information processing apparatus 1, an effect of being capable of generating a set of paired question sentences and their corresponding answer sentences is achieved. Such a set can be used as a Q&A for the target document as it is, and can also be used as training data of the generative model 111A. The generation control unit 104A may cause the generative model 111A to generate a pair of the question sentence and its corresponding answer sentence.

The generative model 111A is a model trained to generate a question sentence regarding the content of the document. It can also be said that the generative model 111A is trained to generate an answer sentence to a question sentence regarding the content of the document. In a case where the similarity determination to be described later is performed by the generative model 111A, it can be said that the generative model 111A is trained to determine the similarity of the sentence or the content of the text. In the present illustrative embodiment, an example in which as the generative model 111A, a language model trained on the arrangement of the components (such as words) of a sentence described in natural language and the arrangement of the sentences in text may be applied will be described.

Similarly to the determination unit 101 included in the information processing apparatus 1 of the first illustrative embodiment, the determination unit 101A determines the similarity of the content of multiple question sentences regarding the content of the target document, which are generated by the generative model 111A. In the present illustrative embodiment, an example in which the determination unit 101A determines the similarity using the generative model 111A will be described, but any method for determining similarity can be used and is not limited to this example. The determination unit 101A may determine the similarity using a language model different from the generative model 111A.

Similarly to the set generation unit 102 included in the information processing apparatus 1 of the first illustrative embodiment, the set generation unit 102A generates a set of question sentences including the multiple question sentences generated by the generative model 111A based on the determination result of the determination unit 101A. The question sentences included in the set generated by the set generation unit 102A are associated with the answer sentences to the question sentences, and are stored in the storage unit 11A as Q&A data 112A.

The training unit 105A updates the generative model 111A by performing machine learning using the question sentences included in the set generated by the set generation unit 102A and the answer sentences to the question sentences as training data. Thus, in addition to the effect obtained by the information processing apparatus 1, an effect of updating the generative model 111A in such a way that an accurate answer to a question regarding the content of the target document can be generated is achieved.

As described above, since the Q&A data 112A is data in which an answer sentence is associated with each question sentence included in the set generated by the set generation unit 102A, the training unit 105A is only required to use the Q&A data 112A as training data.

### (Regarding Generating Question Sentence and Answer Sentence)

As described above, the generation control unit 104A can cause the generative model 111A to generate a question sentence by inputting a prompt including a target document and a sentence instructing to generate a question sentence regarding the content of the target document to the generative model 111A.

For example, in a case where one question sentence regarding the content of the target document is generated, the generation control unit 104A may use a prompt that includes a template sentence such as “Please read the document and generate one question”. The generation control unit 104A can also generate multiple question sentences by using a prompt in which a portion of “one” in the template sentence is changed to another number.

The above-described prompt may include a sentence indicating various constraint conditions. Thus, it is possible to generate a question sentence having the desired content. Examples of the above constraint conditions include generating a question related to the content of the target document, generating a question that can always be answered by reading the target document, using a specific word, and making a clear question that does not cause a person who does not read the target document to misunderstand. In addition, for example, a sentence instructing generation of a question that can be answered with YES or NO, generation of a question asking about a definition of a term described in the target document, and generation of a question asking a method described in the target document may be included in the prompt. In a case where a question sentence for one target document is repeatedly generated, the generation control unit 104A may use a prompt including a sentence instructing to generate a question from a different viewpoint so as not to have the content similar to that of the existing question, along with the previously generated question sentence and target document.

In a case where the generation control unit 104A causes the generative model 111A to generate an answer sentence to the question sentence, the generation control unit 104A is only required to input a prompt including a sentence instructing to generate an answer considered based on the target document to the question, along with the question sentence and the target document, to the generative model 111A. Thus, it is possible to cause the generative model 111A to generate an answer sentence based on the description content of the target document.

The generation control unit 104A can also generate a pair of question-and-answer sentences. In this case, the generation control unit 104A is only required to use a prompt for instructing to generate a question sentence and an answer sentence to the question sentence.

### (Regarding Similarity Determination)

As described above, the determination unit 101A determines the similarity using the generative model 111A. Specifically, the determination unit 101A determines the similarity by inputting, to the generative model 111A, a prompt including multiple question sentences to be determined for similarity and a sentence instructing to output the similarity of the content of the question sentences.

In a case where it is determined whether or not the content of a question sentence to be determined is similar to that of one or more previously generated question sentences, the determination unit 101A may use a prompt including a sentence such as “Please answer “YES” when there is a question sentence similar to the target question sentence among the previously generated question sentences, or answer “NO” when there is no question sentence similar to the target question sentence”. When there is a similar question sentence among the previously generated question sentences, this prompt may include a sentence instructing to output the question sentence. Thus, a user can confirm the validity of the determination result by the determination unit 101A.

In a case where the determination unit 101A determines the degree of similarity in content between the question sentence to be determined and one or more previously generated question sentences, a prompt for instructing to return the similarity as a numerical value is only required to be used. For example, the determination unit 101A may use a prompt including sentences such as “Please answer with a numerical value ranging from zero to one indicating the degree of similarity between the previously generated question sentence and the target question sentence. Please answer each question sentence previously generated. As the numerical value is closer to one, the degree of similarity is higher.”

The determination unit 101A may determine the similarity in consideration of the answer sentence to the question sentence. In this case, the determination unit 101A is only required to input, to the generative model 111A, a prompt including multiple pairs of question-and-answer sentences to be determined for similarity and a sentence instructing to output the similarity of the content of each pair.

The determination unit 101A may use a prompt including a sentence indicating the purpose of determining similarity, context, background, or the entity that determines similarity. Thus, it is possible to improve the accuracy of the determination similarity. For example, the determination unit 101A may use a prompt including a sentence such as “You are an assistant who determines whether or not there is a question sentence similar in content to the target question sentence among the previously generated question sentences”.

### Flowchart: First Example

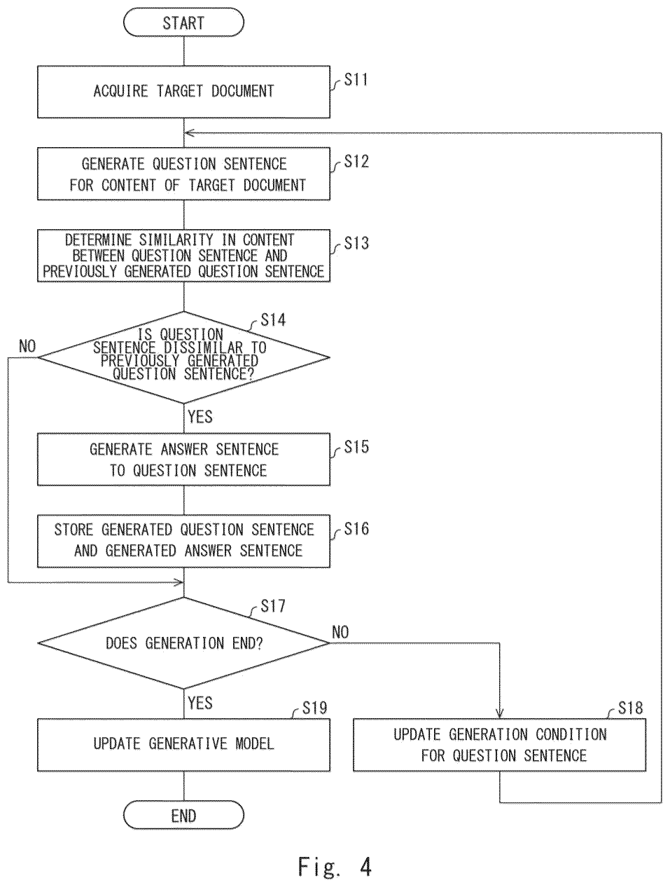

A flow of processing executed by the information processing apparatus 1A will be described with reference to FIG. 4. FIG. 4 is a flowchart illustrating an example of the processing executed by the information processing apparatus 1A. The flowchart of FIG. 4 includes steps of the set generation method according to the present illustrative embodiment.

In S11, the data acquisition unit 103A acquires a target document. A method for acquiring the target document is not particularly limited. For example, the data acquisition unit 103A may acquire the target document input via the input unit 13A, or may acquire the target document stored in another apparatus via the communication unit 12A. For example, the data acquisition unit 103A may acquire audio data of an orally delivered explanation, and acquire the text generated by performing speech recognition on the audio data as the target document.

In S12 (generation control step), the set generation unit 102A instructs the generation control unit 104A to generate a question sentence. The generation control unit 104A causes the generative model 111A to generate the question sentence in response to this instruction. Specifically, the generation control unit 104A causes the generative model 111A to generate the question sentence by inputting a prompt including the target document acquired in S11 and a sentence instructing to generate a question sentence regarding the content of the target document to the generative model 111A. In a case where the question sentence generated in S12 is obviously inappropriate (for example, in a case where the question sentence is not established as a sentence), the set generation unit 102A may discard the question sentence and instruct the generation control unit 104A to generate a new question sentence.

In S13 (determination step), the determination unit 101A determines the similarity in content between the question sentence generated in S12 and question sentences generated prior to that question sentence. In the flow of FIG. 4, the processing in S12 to S18 is repeatedly performed, and since there is no previously generated question sentences in a first loop, S13 is omitted. In a second loop, the similarity in the content between the question sentence generated in S12 in the first loop and the question sentence generated in S12 in the second loop is determined. In a third loop, the similarity in the content between the question sentences generated in S12 in the first and second loops and the question sentence generated in S12 in a third loop is determined. A fourth and subsequent loops are similar to the third loop.

In S14, the set generation unit 102A determines whether or not the content of the question sentence generated in S12 is dissimilar to the content of the question sentence generated prior to the question sentence generated in S12 based on the determination result in S13. For example, the set generation unit 102A may determine dissimilarity in a case where the similarity determined by the determination unit 101A in S13 is equal to or less than a predetermined threshold. In a case where the determination unit 101A determines the similarity or dissimilarity in S13, the set generation unit 102A is only required to set the determination result in S13 as the determination result in S14.

In the third and subsequent loops, the set generation unit 102A determines the similarity between the most recently generated question sentence and each of the multiple question sentences generated prior to the most recently generated question sentence, and sets the determination result in S14 to YES in a case where all the determination results are dissimilar. On the other hand, in a case where at least one determination result is similar, the set generation unit 102A sets the determination result in S14 to NO. The set generation unit 102A determines YES in S14 in the first loop.

In a case where YES is determined in S14, the processing proceeds to S15. In S15, the generation control unit 104A causes the generative model 111A to generate an answer sentence to the question sentence (question sentence determined to be dissimilar to any of the previously generated question sentences) generated in S12. Specifically, the generation control unit 104A causes the generative model 111A to generate an answer sentence by inputting, to the generative model 111A, the question sentence, the target document, and a prompt for instructing to generate the answer sentence to the question sentence based on the content of target text. In a case where the answer sentence generated in S15 is obviously inappropriate (for example, in a case where the answer sentence is not established as a sentence), the set generation unit 102A may instruct the generation control unit 104A to regenerate the answer sentence.

In S16, the set generation unit 102A associates the question sentence generated in S12 with the answer sentence to the question sentence (the answer sentence generated in S15) to obtain the Q&A data 112A, and stores the Q&A data 112A in the storage unit 11A. The set generation unit 102A may present the Q&A data 112A to the user by causing the output unit 14A to output the Q&A data 112A. After the completion of S16, the processing proceeds to S17.

The processing of S15 can be omitted. In a case where the processing of S15 is omitted, the set generation unit 102A may cause the storage unit 11A to store only the question sentence. The set generation unit 102A may present the question sentence to the user by causing the output unit 14A to output the question sentence, and may cause the user to input the answer sentence. In this case, in S16, the set generation unit 102A associates the generated question sentence with the answer sentence input by the user to set the Q&A data 112A.

In a case where NO is determined in S14, the processing proceeds to S17 without performing the processing in S15 and S16. That is, for the question sentence determined as NO in S14, no answer sentence is generated and is not stored in the storage unit 11A. Thus, a set including pairs of question sentences having dissimilar contents and their corresponding answer sentences as elements is generated and stored as the Q&A data 112A. That is, in the flow of FIG. 4, it can be said that the series of processing in S12 to S18 is a set generation step of generating a set of question sentences based on the determination result of the similarity.

In S17, the set generation unit 102A determines whether to end the generation of the question sentence. In a case where it is determined as NO in S17, the set generation unit 102A instructs the generation control unit 104A to change the generation condition for the question sentence and generate the question sentence. Thus, the processing proceeds to S18. On the other hand, in a case where YES is determined in S17, the processing proceeds to S19.

The determination condition in S17 is only required to be appropriately determined. For example, the set generation unit 102A may determine to end the generation of the question sentence in a case where the number of repetitions of the processing in S12 to S18 reaches a predetermined upper limit. The upper limit number of times is only required to be appropriately set according to the number of Q&As to be generated, the volume of the target document, and the like. For example, the set generation unit 102A may determine to end generation of the question sentence in a case where the number of stored question sentences (and answer sentences corresponding thereto) reaches a predetermined upper limit. In this case, the number of Q&As to be generated is only required to be set to the upper limit.

As the processing in S12 to S18 is repeated, the total number of question sentences (and answer sentences corresponding thereto) stored in S16 increases, and thus the ratio of dissimilarity determination in S14 decreases. When the question sentence stored in S16 covers the entire target document, the ratio of question sentences determined to be dissimilar in S14 becomes zero or a value close to zero.

Therefore, for example, the set generation unit 102A may determine to end the generation of the question sentence in a case where the ratio of question sentences dissimilar to any of the previously generated question sentences among the multiple question sentences generated by repeating the processing in S12 to S18 for the most recent predetermined number of times is equal to or less than a predetermined threshold. Thus, in addition to the effect obtained by the information processing apparatus 1, an effect of ending the generation of the question sentence at an appropriate timing and generating a set of question sentences that evenly covers the entire target document is achieved.

For example, in a case where the predetermined number of times is set to five and the threshold is set to ⅕, the set generation unit 102A ends the generation of the question sentence when the number of question sentences determined to be dissimilar in S14 among the most recently generated five question sentences is zero or one. The threshold may be set to zero. In this case, when all the predetermined number of question sentences generated most recently are determined to be dissimilar in S14, in other words, when the determination result in S14 is continuously dissimilar a predetermined number of times, the set generation unit 102A ends the generation of the question sentence.

In S18, the generation control unit 104A changes the generation condition for the question sentence. After S18, the processing returns to S12, and the generation control unit 104A applies the changed generation condition to cause the generative model 111A to generate a new question sentence.

The generation condition to be changed in S18 is arbitrary and is only required to be determined in advance. For example, the generation control unit 104A may change the value of the randomness parameter (for example, temperature parameter) in the generative model 111A in such a way that more various question sentences are generated. The randomness parameter is a hyperparameter for controlling diversity of options in the generative model 111A, and by adjusting the hyperparameters, the generative model 111A can generate various question sentences.

In S18, the generation control unit 104A may change the prompt to be input to the generative model 111A. In this case, a plurality of types of prompts are only required to be prepared in advance. In addition, multiple patterns of prompt components may be prepared. In this case, the generation control unit 104A can change the generation condition by changing the combination of these components.

It is not always necessary to change the generation condition for the question sentence every time NO is determined in S17. For example, the generation condition for the question sentence may be changed every time the cumulative number of times NO is determined in S17 reaches a predetermined number.

In a case where YES is determined in S17, that is, when generation of the question sentence ends, the processing proceeds to S19. In S19 (training step), the training unit 105A updates the generative model 111A by performing machine learning using, as training data, question sentences included in a set of the question sentences generated by repeating the processing in S12 to S18 and an answer sentence to each of the question sentences. Specifically, the training unit 105A updates the generative model 111A by performing machine learning using the Q&A data 112A stored in the storage unit 11A as training data. Thus, the processing of FIG. 4 ends.

As described above, the information processing apparatus 1A includes the generation control unit 104A that causes the generative model 111A to generate the question sentence. The set generation unit 102A may generate a set of question sentences by causing the generation control unit 104A to generate a question sentence and repeating the processing of adding the generated question sentence to the set when the generated question sentence is dissimilar to any of the previously generated question sentences until a predetermined condition is satisfied. Thus, in addition to the effect obtained by the information processing apparatus 1, an effect of generating a set of question sentences having dissimilar contents is achieved.

As described above, in a case where the content of the question sentence generated by the generative model 111A is similar to the content of any previously generated question sentence, the generation control unit 104A may change the generation condition for causing the generative model 111A to generate a question sentence. Thus, in addition to the effect obtained by the information processing apparatus 1, an effect of increasing the coverage of the generated set with respect to the target document is achieved.

In a case where the generated set is used for training, the set generation unit 102A may include the question sentences having similar content in the set. By using the training data appropriately including question sentences having similar content, it can be expected that the accuracy of the generative model 111A is improved. What ratio of question sentences having similar content is included (in other words, the sampling rate of questions having similar content and dissimilar questions) is only required to be determined in advance.

### Flowchart: Second Example

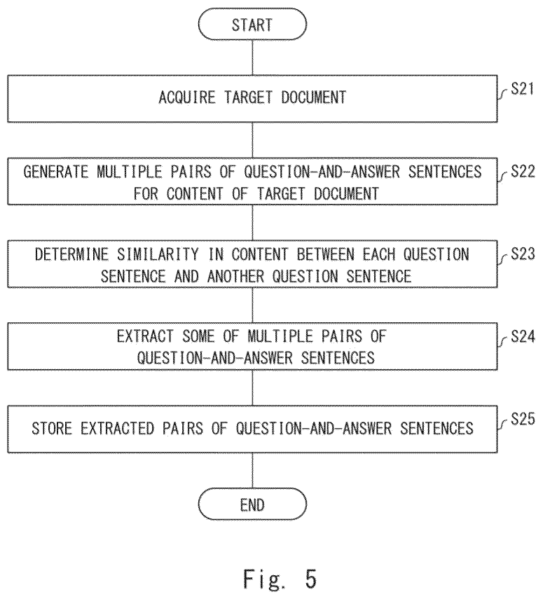

FIG. 5 is a flowchart illustrating another example of processing executed by the information processing apparatus 1A. The flowchart of FIG. 5 includes steps of the set generation method according to the present illustrative embodiment. S21 and S25 are processing similar to that in S11 and S16 of FIG. 4, respectively, and thus the description thereof will not be repeated.

In S22, the set generation unit 102A instructs the generation control unit 104A to generate multiple pairs of question-and-answer sentences. The generation control unit 104A causes the generative model 111A to generate multiple pairs of question-and-answer sentences in response to this instruction. Specifically, the generation control unit 104A causes the generative model 111A to generate the multiple pairs of question-and-answer sentences by inputting, to the generative model 111A, a prompt including the target document acquired in S21 and a sentence instructing to generate multiple pairs of a question sentence regarding the content of the target document and an answer sentence to the question sentence.

In S22, the generation control unit 104A may generate multiple pairs of the question-and-answer sentences by repeatedly performing the processing of causing the generative model 111A to generate the question sentence and the answer sentence while changing the generation condition (for example, the above-described randomness parameter and the prompt to be used). The generation control unit 104A may generate multiple pairs of question-and-answer sentences by repeating the processing of generating multiple pairs of question-and-answer sentences under a certain generation condition and then changing the generation condition to generate multiple pairs of question-and-answer sentences.

The set generation unit 102A may exclude an obviously inappropriate pair (for example, a pair that is not established as a sentence) from the pairs of question-and-answer sentences generated in S22. In the flow of FIG. 5, since the generation of the question sentence is not repeatedly performed, the number of pairs of question-and-answer sentences generated in S22 is preferably set to be larger than the number of generated question sentences that cover the entire target document.

In S23 (determination step), the determination unit 101A determines the similarity in content between each question sentence generated in S22 and another question sentence generated in S22. For example, when n (n is a natural number) pairs of question-and-answer sentences are generated in S22, the determination unit 101A determines the similarity between question sentences included in the n pairs and question sentences included in another (n−1) pairs.

In S23, the determination unit 101A may also determine the similarity in consideration of the answer sentence. In this case, the determination unit 101A is only required to input two pairs of question-and-answer sentences to the generative model 111A and output their similarity. The determination unit 101A may input, to the generative model 111A, a prompt including each question sentence generated in S22 and a sentence instructing to extract a question sentence dissimilar to any of the other question sentences to cause the question sentence to be extracted. In this case, the determination unit 101A is only required to determine the extracted question sentence as a dissimilar question sentence. Similarly, the determination unit 101A may input each question sentence generated in S22 to the generative model 111A to extract a question sentence similar to at least any of the other question sentences. In this case, the determination unit 101A is only required to determine the question sentence, which is not extracted, as a dissimilar question sentence.

In S24, the set generation unit 102A extracts some of the multiple pairs of question-and-answer sentences generated in S22 to generate a set of question sentences (including the corresponding answer sentences). More specifically, the set generation unit 102A generates the set by extracting a part of the multiple question sentences in such a way that the ratio of question sentences dissimilar to other question sentences is equal to or greater than a predetermined lower limit value among the multiple question sentences generated in S22 under the control of the generation control unit 104A. Thus, in addition to the effect obtained by the information processing apparatus 1, an effect of generating a set appropriately including question sentences having similar content is achieved. Such a set can be suitably used for retraining the generative model 111A.

After the processing of S25, the generative model 111A may be updated as in S19 of FIG. 4. Only multiple question sentences may be generated in S22. In this case, before the processing of S25 is performed, an answer sentence corresponding to each question sentence is only required to be generated by processing as in S15 of FIG. 4. Similarly to the example of FIG. 4, the generated question sentence and answer sentence may be presented to the user by causing the output unit 14A to output the generated question sentence and answer sentence.

### Flowchart: Third Example

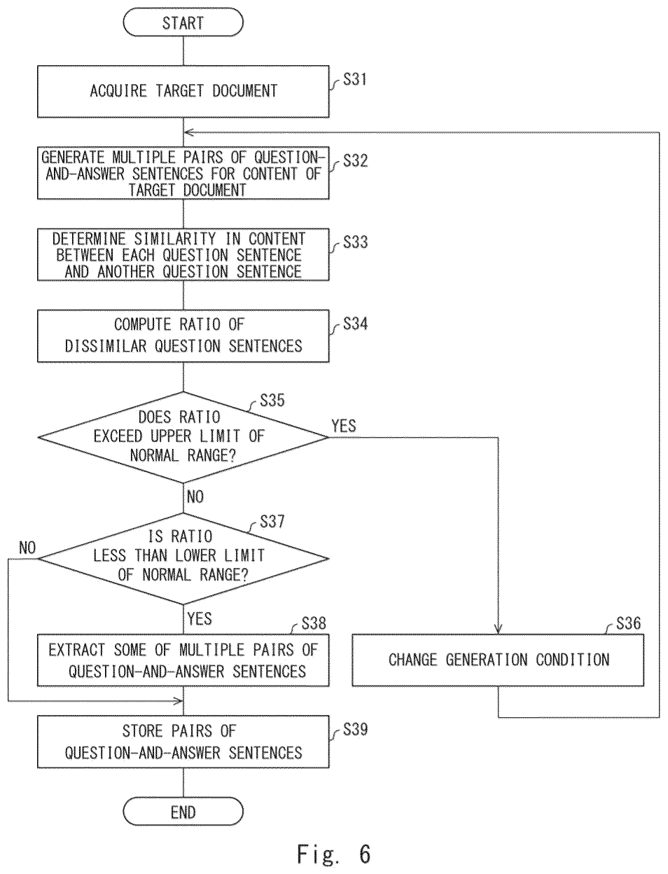

FIG. 6 is a flowchart illustrating still another example of processing executed by the information processing apparatus 1A. The flowchart of FIG. 6 includes steps of the set generation method according to the present illustrative embodiment. S31 and S39 are processing similar to that in S11 and S16 of FIG. 4, respectively, and thus the description thereof will not be repeated. S33 and S38 are processing similar to that in S23 and S24 of FIG. 5, respectively, and thus the description thereof will not be repeated.

In S34, the set generation unit 102A computes the ratio of dissimilar question sentences with respect to multiple question sentences generated in S32 based on the determination result in S33. Note that, in S32, multiple pairs of question-and-answer sentences are only required to be generated as in S22 of FIG. 5. However, since generation of the question sentence and the answer sentence can be repeatedly performed in the flow of FIG. 6, it is not necessary to generate a larger number of question sentences and a larger number of answer sentences in S32.

In S35, the set generation unit 102A determines whether or not the ratio computed in S34 exceeds the upper limit of a predetermined normal range. In a case where it is determined as YES in S35, the set generation unit 102A instructs the generation control unit 104A to change the generation condition for the question sentence and answer sentence, and generate the question sentence and answer sentence. Thus, the processing proceeds to S36. On the other hand, in a case where NO is determined in S35, the processing proceeds to S37.

In S36, the generation control unit 104A changes the generation condition for the question sentence and the answer sentence as in S18 of FIG. 4. After S36, the processing returns to S32, and the generation control unit 104A applies the changed generation condition to cause the generative model 111A to generate a new question sentence and a new answer sentence. In the processing of S32 which transitions from S36, it is not necessary to generate the same number of question sentences and answer sentences as the number of question sentences and answer sentences in a first turn of S32. For example, in the proceeding of S32 which transitions from S36, the generation control unit 104A may generate a pair of question-and-answer sentences.

In S37, the set generation unit 102A determines whether or not the ratio computed in S34 is less than the lower limit of a predetermined normal range. In a case where YES is determined in S37, the processing proceeds to S38. In this case, the set generation unit 102A extracts some of multiple pairs of question-and-answer sentences generated in S32 to generate a set of question sentences (including the corresponding answer sentences) (S38), and stores the set in the storage unit 11A as Q&A data 112A (S39).

On the other hand, in a case where NO is determined in S37, the set generation unit 102A proceeds to S39 without performing the processing of S38. In this case, the set generation unit 102A causes the storage unit 11A to store the multiple pairs of question-and-answer sentences generated in S32 as Q&A data 112A. In a case where the processing in S32 to S36 is repeated multiple times, the set generation unit 102A is only required to cause the storage unit 11A to store all the pairs of question-and-answer sentences obtained through repetition of the processing as the Q&A data 112A.

As described above, in a case where the ratio of question sentences dissimilar to other question sentences among multiple question sentences generated under the control of the generation control unit 104A exceeds a predetermined upper limit value, the set generation unit 102A may generate a set of question sentences by repeating processing of causing the generation control unit 104A to generate a new question sentence until the ratio becomes equal to or less than the upper limit value. Thus, in addition to the effect obtained by the information processing apparatus 1, an effect of generating a set appropriately including question sentences having similar content is achieved. Such a set can be suitably used for retraining the generative model 111A.

After the processing of S39, the generative model 111A may be updated as in S19 of FIG. 4. Only multiple question sentences may be generated in S32. In this case, before the processing of S39 is performed, an answer sentence corresponding to each question sentence is only required to be generated by processing as in S15 of FIG. 4. Similarly to the example of FIG. 4, the generated question sentence and answer sentence may be presented to the user by causing the output unit 14A to output the generated question sentence and answer sentence.

### [Implementation Example by Software]

Some or all of the functions of the information processing apparatuses 1 and 1A may be implemented by hardware such as an integrated circuit (IC chip) or may be implemented by software.

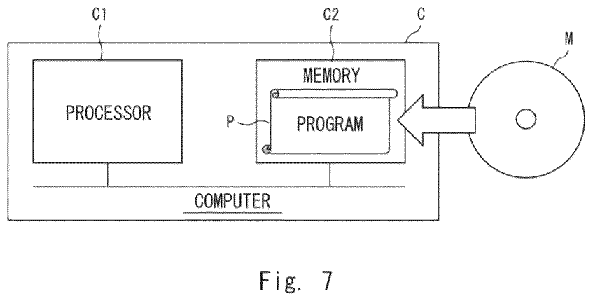

In the latter case, the information processing apparatuses 1 and 1A are achieved, for example, by a computer that executes an instruction of a program that is software for implementing each function. An example of such a computer (hereinafter, referred to as a computer C) is illustrated in FIG. 7. FIG. 7 is a block diagram illustrating the hardware configuration of the computer C that functions as the information processing apparatuses 1 and 1A.

The computer C includes at least one processor C1 and at least one memory C2. A program (set generation program) P for causing the computer C to operate as the information processing apparatus 1 or 1A is recorded in the memory C2. In the computer C, the processor C1 reads the program P from the memory C2 and executes the program P, and thus the function of the information processing apparatus 1 or 1A is implemented.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can acquire the program P via such a transmission medium.

Each of the above-described functions of the information processing apparatuses 1 and 1A may be implemented by a single processor provided in a single computer, may be implemented by cooperation of multiple processors provided in the single computer, or may be implemented by cooperation of multiple processors provided in each of the multiple computers. The program for causing the information processing apparatus 1 or 1A to implement the above-described functions may be stored in a single memory provided in a single computer, may be stored in a distributed manner in multiple memories provided in a single computer, or may be stored in a distributed manner in multiple memories provided in each of multiple computers.

### [Supplementary Notes]

The present disclosure includes the technologies described in the following supplementary notes. However, the present disclosure is not limited to the technologies described in the following supplementary note, and various modifications can be made within the scope described in the claims.

### (Supplementary Note A)

### (Supplementary Note A1)

An information processing apparatus including: a determination means for determining similarity of content for multiple question sentences regarding the content of a target document, which are generated by a generative model trained to generate question sentences regarding the content of a document; and a set generation means for generating a set of question sentences including the multiple question sentences generated by the generative model based on a determination result of the determination means.

### (Supplementary Note A2)

The information processing apparatus according to Supplementary note A1, further including a generation control means for causing the generative model to generate the question sentences, in which the set generation means generates the set by causing the generation control means to generate the question sentences and repeating processing of adding the question sentences to the set when the generated question sentences are dissimilar to any of the previously generated question sentences until a predetermined condition is satisfied.

### (Supplementary Note A3)

The information processing apparatus according to Supplementary note A2, in which the predetermined condition is that a ratio of question sentences dissimilar to any of the previously generated question sentences among multiple question sentences generated by repeating the processing for a most recent predetermined number of times is equal to or less than a predetermined threshold.

### (Supplementary Note A4)

The information processing apparatus according to Supplementary note A2 or A3, in which in a case where content of the question sentences generated by the generative model is similar to the content of any of the previously generated question sentences, the generation control means changes a generation condition for causing the generative model to generate question sentences.

### (Supplementary Note A5)

The information processing apparatus according to Supplementary note A1, further including a generation control means for causing the generative model to generate the question sentences, in which the set generation means generates the set by extracting some of multiple question sentences in such a way that a ratio of question sentences dissimilar to other question sentences among the multiple question sentences generated under the control of the generation control means is equal to or greater than a predetermined lower limit value.

### (Supplementary Note A6)

The information processing apparatus according to Supplementary note A1, further including a generation control means for causing the generative model to generate the question sentences, in which in a case where a ratio of question sentences dissimilar to other question sentences among multiple question sentences generated under the control of the generation control means exceeds a predetermined upper limit value, the set generation means generates the set by repeating processing of causing the generation control means to generate new question sentences until the ratio becomes equal to or less than the upper limit value.

### (Supplementary Note A7)

The information processing apparatus according to any one of Supplementary notes A1 to A6, further including a generation control means for causing a generative model trained to generate an answer sentence to a question sentence regarding content of a document to generate an answer sentence to each question sentence included in the set.

### (Supplementary Note A8)

The information processing apparatus according to Supplementary note A7, further including a training means for updating the generative model trained to generate the answer sentence to the question sentence regarding the content of the document by performing machine learning using each question sentence included in the set and the answer sentence to the each question sentence as training data.

### (Supplementary Note B)

### (Supplementary Note B1)

A set generation method including causing at least one processor to execute: a determination step of determining similarity of content for multiple question sentences regarding the content of a target document, which are generated by a generative model trained to generate question sentences regarding the content of the document; and a set generation step of generating a set of question sentences including the multiple question sentences generated by the generative model based on a determination result in the determination step.

### (Supplementary Note B2)

The set generation method according to Supplementary note B1, further including a generation control step of causing the at least one processor to cause the generative model to generate the question sentences, in which the at least one processor generates the set by generating the question sentences in the generation control step and repeating processing of adding the question sentences to the set when the generated question sentences are dissimilar to any of the previously generated question sentences until a predetermined condition is satisfied.

### (Supplementary Note B3)

The set generation method according to Supplementary note B2, in which the predetermined condition is that a ratio of question sentences dissimilar to any of the previously generated question sentences among multiple question sentences generated by repeating the processing for a most recent predetermined number of times is equal to or less than a predetermined threshold.

### (Supplementary Note B4)

The set generation method according to Supplementary note B2 or B3, in which in a case where content of the question sentences generated by the generative model in the generation control step is similar to the content of any of the previously generated question sentences, the at least one processor changes a generation condition for causing the generative model to generate question sentences.

### (Supplementary Note B5)

The set generation method according to Supplementary note B1, further including a generation control step of causing the at least one processor to cause the generative model to generate the question sentences, in which the at least one processor generates the set by extracting some of multiple question sentences in such a way that a ratio of question sentences dissimilar to other question sentences among the multiple question sentences generated in the generation control step is equal to or greater than a predetermined lower limit value.

### (Supplementary Note B6)

The set generation method according to Supplementary note B1, further including a generation control step of causing the at least one processor to cause the generative model to generate the question sentences, in which the at least one processor generates the set by repeating processing of causing the generative model to generate new question sentences until a ratio of question sentences dissimilar to other question sentences among multiple question sentences generated in the generation control step is equal to or less than a predetermined upper limit value in a case where the ratio exceeds the upper limit value.

### (Supplementary Note B7)

The set generation method according to any one of Supplementary notes B1 to B6, further including a step of causing the at least one processor to cause the generative model trained to generate an answer sentence to a question sentence regarding content of a document to generate an answer sentence to each question sentence included in the set.

### (Supplementary Note B8)

The set generation method according to Supplementary note B7, further including a training step of causing the at least one processor to update the generative model trained to generate the answer sentence to the question sentence regarding the content of the document by performing machine learning using each question sentence included in the set and the answer sentence to the each question sentence as training data.

### (Supplementary Note C)

### (Supplementary Note C1)

A set generation program causing a computer to function as: a determination means for determining similarity of content for multiple question sentences regarding the content of a target document, which are generated by a generative model trained to generate question sentences regarding the content of a document; and a set generation means for generating a set of question sentences including the multiple question sentences generated by the generative model based on a determination result of the determination means.

### (Supplementary Note C2)

The set generation program according to Supplementary note C1, further causing the computer to function as a generation control means for causing the generative model to generate the question sentences, in which the set generation means generates the set by causing the generation control means to generate the question sentences and repeating processing of adding the question sentences to the set when the generated question sentences are dissimilar to any of the previously generated question sentences until a predetermined condition is satisfied.

### (Supplementary Note C3)

The set generation program according to Supplementary note C2, in which the predetermined condition is that a ratio of question sentences dissimilar to any of the previously generated question sentences among multiple question sentences generated by repeating the processing for a most recent predetermined number of times is equal to or less than a predetermined threshold.

### (Supplementary Note C4)

The set generation program according to Supplementary note C2 or C3, in which in a case where content of the question sentences generated by the generative model is similar to the content of any of the previously generated question sentences, the generation control means changes a generation condition for causing the generative model to generate question sentences.

### (Supplementary Note C5)

The set generation program according to Supplementary note C1, further causing the computer to function as a generation control means for causing the generative model to generate the question sentences, in which the set generation means generates the set by extracting some of multiple question sentences in such a way that a ratio of question sentences dissimilar to other question sentences among the multiple question sentences generated under the control of the generation control means is equal to or greater than a predetermined lower limit value.

### (Supplementary Note C6)

The set generation program according to Supplementary note C1, further causing the computer to function as a generation control means for causing the generative model to generate the question sentences, in which in a case where a ratio of question sentences dissimilar to other question sentences among multiple question sentences generated under the control of the generation control means exceeds a predetermined upper limit value, the set generation means generates the set by repeating processing of causing the generation control means to generate new question sentences until the ratio becomes equal to or less than the upper limit value.

### (Supplementary Note C7)

The set generation program according to any one of Supplementary notes C to C6, further causing the computer to function as a generation control means for causing a generative model trained to generate an answer sentence to a question sentence regarding content of a document to generate an answer sentence to each question sentence included in the set.

### (Supplementary Note C8)

The set generation program according to Supplementary note C7, further causing the computer to function as a training means for updating the generative model trained to generate the answer sentence to the question sentence regarding the content of the document by performing machine learning using each question sentence included in the set and the answer sentence to the each question sentence as training data.

### (Supplementary Note D)

### (Supplementary Note D1)

An information processing apparatus including at least one processor, in which the at least one processor executes: a determination step of determining similarity of content for multiple question sentences regarding the content of a target document, which are generated by a generative model trained to generate question sentences regarding the content of the document; and a set generation step of generating a set of question sentences including the multiple question sentences generated by the generative model based on a determination result in the determination step.

The information processing apparatus may further include a memory. The memory may store a program for causing the at least one processor to execute each processing.

### (Supplementary Note D2)

The information processing apparatus according to Supplementary note D1, in which the at least one processor generates the set by causing the generative model to generate the question sentences and repeating processing of adding the question sentences to the set when the generated question sentences are dissimilar to any of the previously generated question sentences until a predetermined condition is satisfied.

### (Supplementary Note D3)

The information processing apparatus according to Supplementary note D2, in which the predetermined condition is that a ratio of question sentences dissimilar to any of the previously generated question sentences among multiple question sentences generated by repeating the processing for a most recent predetermined number of times is equal to or less than a predetermined threshold.

### (Supplementary Note D4)

The information processing apparatus according to Supplementary note D2 or D3, in which in a case where content of the question sentences generated by the generative model is similar to the content of any of the previously generated question sentences, the at least one processor changes a generation condition for causing the generative model to generate question sentences.

### (Supplementary Note D5)

The information processing apparatus according to Supplementary note D1, in which the at least one processor generates the set by extracting some of multiple question sentences in such a way that a ratio of question sentences dissimilar to other question sentences among the multiple question sentences generated by the generative model is equal to or greater than a predetermined lower limit value.

### (Supplementary Note D6)

The information processing apparatus according to Supplementary note D1, in which in a case where a ratio of question sentences dissimilar to other question sentences among multiple question sentences generated by the generative model exceeds a predetermined upper limit value, the at least one processor generates the set by repeating processing of causing the generative model to generate new question sentences until the ratio becomes equal to or less than the upper limit value.

### (Supplementary Note D7)

The information processing apparatus according to any one of Supplementary notes D1 to D6, in which the at least one processor causes a generative model trained to generate an answer sentence to a question sentence regarding content of a document to generate an answer sentence to each question sentence included in the set.

### (Supplementary Note D8)

The information processing apparatus according to Supplementary note D7, in which the at least one processor updates the generative model trained to generate the answer sentence to the question sentence regarding the content of the document by performing machine learning using each question sentence included in the set and the answer sentence to the each question sentence as training data.

### (Supplementary Note E)

A non-transitory recording medium storing a set generation program for causing a computer to execute: determination processing of determining similarity of content for multiple question sentences regarding the content of a target document, which are generated by a generative model trained to generate question sentences regarding the content of a document; and set generation processing of generating a set of question sentences including the multiple question sentences generated by the generative model based on a determination result of the determination processing.

According to an example aspect of the present disclosure, an exemplary effect of enabling generation of a set of questions covering the entire target document is achieved.

What is claimed is:

1. An information processing apparatus comprising:
at least one memory configured to store instructions; and
at least one processor configured to execute the instructions to:
determine similarity of content for multiple question sentences regarding the content of a target document, which are generated by a generative model trained to generate question sentences regarding the content of a document; and
generate a set of question sentences including the multiple question sentences generated by the generative model based on a determination result.

2. The information processing apparatus according to claim 1, wherein the at least one processor executes the instructions to:
cause the generative model to generate the question sentences;
generate the set to generate the question sentences and repeat processing of adding the question sentences to the set when the generated question sentences are dissimilar to any of the previously generated question sentences until a predetermined condition is satisfied.

3. The information processing apparatus according to claim 2, wherein the predetermined condition is that a ratio of question sentences dissimilar to any of the previously generated question sentences among multiple question sentences generated by repeating the processing for a most recent predetermined number of times is equal to or less than a predetermined threshold.

4. The information processing apparatus according to claim 2, wherein in a case where content of the question sentences generated by the generative model is similar to the content of any of the previously generated question sentences, the at least one processor executes the instructions to change a generation condition for causing the generative model to generate question sentences.

5. The information processing apparatus according to claim 1, wherein the at least one processor executes the instructions to:
cause the generative model to generate the question sentences;
generate the set by extracting some of multiple question sentences in such a way that a ratio of question sentences dissimilar to other question sentences among the multiple question sentences generated is equal to or greater than a predetermined lower limit value.

6. The information processing apparatus according to claim 1, the at least one processor executes the instructions to:
cause the generative model to generate the question sentences;
in a case where a ratio of question sentences dissimilar to other question sentences among multiple question sentences generated exceeds a predetermined upper limit value, generate the set by repeating processing to generate new question sentences until the ratio becomes equal to or less than the upper limit value.

7. The information processing apparatus according to claim 1, the at least one processor executes the instructions to cause a generative model trained to generate an answer sentence to a question sentence regarding content of a document to generate an answer sentence to each question sentence included in the set.

8. The information processing apparatus according to claim 7, the at least one processor executes the instructions to update the generative model trained to generate the answer sentence to the question sentence regarding the content of the document by performing machine learning using each question sentence included in the set and the answer sentence to the each question sentence as training data.

9. A set generation method comprising causing at least one processor to execute:
a determination step of determining similarity of content for multiple question sentences regarding the content of a target document, which are generated by a generative model trained to generate question sentences regarding the content of the document; and
a set generation step of generating a set of question sentences including the multiple question sentences generated by the generative model based on a determination result in the determination step.

10. A non-transitory computer-readable medium storing a set generation program for causing a computer to execute:
determination processing of determining similarity of content for multiple question sentences regarding the content of a target document, which are generated by a generative model trained to generate question sentences regarding the content of a document; and
set generation processing of generating a set of question sentences including the multiple question sentences generated by the generative model based on a determination result of the determination processing.
